(19) United States
(12) Patent Application Publication
(10) Pub. No.: US 2003/0177487 A1
(43) Pub. Date: Sep. 18, 2003

(54) Recording medium capable of quickly generating server function and manufacturing method thereof

(76) Inventor: Charles Chyan, Banchiau City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/098,362

(22) Filed: Mar. 18, 2002

(51) Int. Cl. G06F 9/445

(52) U.S. Cl. 717/174

(57) ABSTRACT

The present invention relates to a recording medium capable of quickly generating server functions and a manufacturing method thereof. The whole function of a computer server is added in the required OS to make a recording medium having an auto-boot mechanism. The recording medium produced in this way includes all the required software of a specific server. After a computer hardware is turned on, it will automatically execute to become a server having the specific function. Therefore, the present invention can let a common user generate the required server functions easily, quickly, and effectively.

### FIELD OF THE INVENTION

The present invention relates to the generation of various kinds of server functions widely used in computer network and, more particularly, to a recording medium capable of quickly generating server functions and a manufacturing method thereof.

### BACKGROUND OF THE INVENTION

A server usually means a computer for performing management software to control network access and usage resource so as to provide the required disk or printing services for users. Servers are very important elements in computer network. Each kind of specific server can provide its specific service for many computers in the network. However, the required professional knowledge and efforts usually let most users from using these services.

In the prior art, to install a server needs to undergo the following tedious steps:

(1) First, an operating system (OS) is installed in a computer;

(2) The installer sets the specific server software with his professional knowledge and experience to finish installing a server having a specific function;

(3) Test and adjustment are proceeded to perfect the server function;

(4) Finally, prior setting for preventing of virus is performed to finish the whole installing procedure.

In the prior art, all the above steps must be repeated once when adding in a server. The installing procedure is very professional and complicated. Not every one can accomplish the work. Most users cannot install the servers themselves to enjoy the use of these server functions. Accordingly, the present invention aims to propose a recording medium of simple operation capable of quickly generating server functions and a manufacturing method thereof to effectively solve the problems in the prior art.

### SUMMARY OF THE INVENTION

The primary object of the present invention is to propose a recording medium capable of quickly generating server functions and a manufacturing method thereof. The recording medium is exploited to let the installation and use of server be very simple, fast, and convenient so that common users can install and use these special server functions themselves.

Another object of the present invention is to propose a recording medium capable of quickly generating server functions and a manufacturing method thereof, which can be replicated in large quantity, and can popularize computer network services.

Yet another object of the present invention is to propose a recording medium capable of quickly generating server functions and a manufacturing method thereof, which can provide network services immune to threat of virus.

Still yet another object of the present invention is to propose a recording medium capable of quickly generating server functions and a manufacturing method thereof, which can let computers to be eliminated through competition exploit their value again.

To achieve the above objects, in the present invention, an OS kernel for driving computer hardware is first provided. Next, server functions and an auto-boot mechanism are added into the OS kernel to assemble an OS. The OS is then written into a recording medium to produce a recording medium source disk. Finally, this recording medium source disk can be used to manufacture many recording media having the auto-boot mechanism and the server OS of specific functions.

The various objects and advantages of the present invention will be more readily understood from the following detailed description when read in conjunction with the appended drawings, in which:

### BRIEF DESCRIPTION OF THE DRAWINGS

FIG. 1 is a flowchart of manufacturing a recording medium of the present invention; and

FIG. 2 is a diagram showing how the recording medium is used to generate server functions in the present invention.

### DETAILED DESCRIPTION OF THE PREFERRED EMBODIMENTS

The present invention utilizes a recording medium capable of automatically generating server functions. The procedure of manufacturing a recording medium source disk is performed once to replicate recording medium in large quantity or customize special recording medium, thereby achieving the object of quickly generating server functions through the recording medium.

The recording medium disclosed in the present invention is applied to computer network to generate various kinds of server functions. The recording medium is formed by building a read-only image file of an OS having server functions and turning-on mechanism in a blank recording medium. When a specific server function is to be generated in a computer hardware, the specific recording medium is first placed in a reader of the computer hardware. After the computer hardware is turned on, this recording medium automatically starts to execute to let the computer hardware quickly generate the required server function.

The above recording medium can be a common CD-recordable (CD-R) disk, a CD-rewritable (CD-RW) disk, or other device supporting the boot function so that manufacturers can write the required OS having the server function and the boot mechanism into the recording medium, which can be used as a tool medium capable of quickly generating the server function.

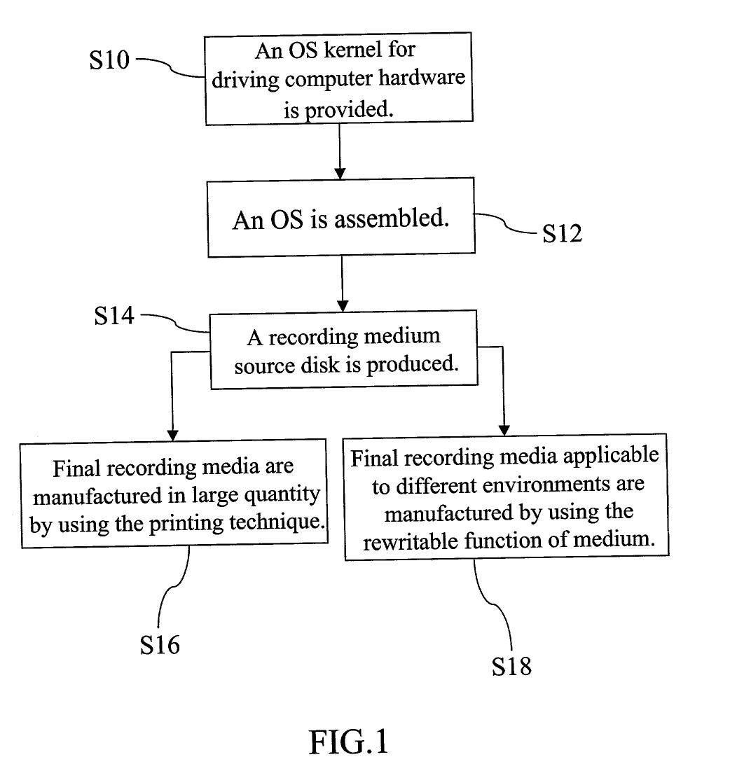

As shown in FIG. 1, the manufacturing method of the present invention comprises the following steps.

First, as Step S10 shows, an OS kernel for driving computer hardware is provided. Next, a specific preset server function and a boot mechanism are added into the OS kernel. Simultaneously, all software elements impertinent to the preset server function (service) are removed, and the required optimizing settings for the preset server function are embedded therein, thereby assembling an OS, as Step S12 shows.

The OS is then written into a recording medium (e.g., a CD disk or a device supporting the boot function) using a recorder or other recording device so as to produce a recording medium source disk, as Step S14 shows.

After the recording medium source disk is finished, subsequent steps can mainly be divided into two ways. The first is as Step S16 shows, wherein printing technique is exploited to replicate the recording medium source disk in large quantity to manufacture many identical final recording mediums. Each of the final recording mediums replicated in this way can generate the same preset server function. The other way is as Step S18 shows, wherein, based on various kinds of different necessities of customer, the recording medium source disk is regenerated to manufacture final recording medium applicable to different environments by using the rewritable function of the recording medium. The final recording medium is placed into a target machine. After the target machine is turned on, it will automatically generate the preset server function.

The above server function can be server function provided by a MAIL server, a network address translation (NAT) server, a domain name server (DNS), a PROXY server, a network attached storage (NAS) server, or a dynamic host configuration protocol (DHCP) server.

For instance, if the recording medium of the present invention uses a presently widespread CD-R disk, because CD drives are installed in most present computers, and the cost and printing expense of the CD-R disk are very low, the CD-R disk will become a very economic read-only recording medium. Combined with powerful functions of servers, the advantage of replication in large quantity can be achieved, and the installation and use of server functions will become very simple, convenient, and popular. Moreover, because of the unrewritable characteristic of the CD-R recording medium, the server function will not be damaged due to invasion of virus.

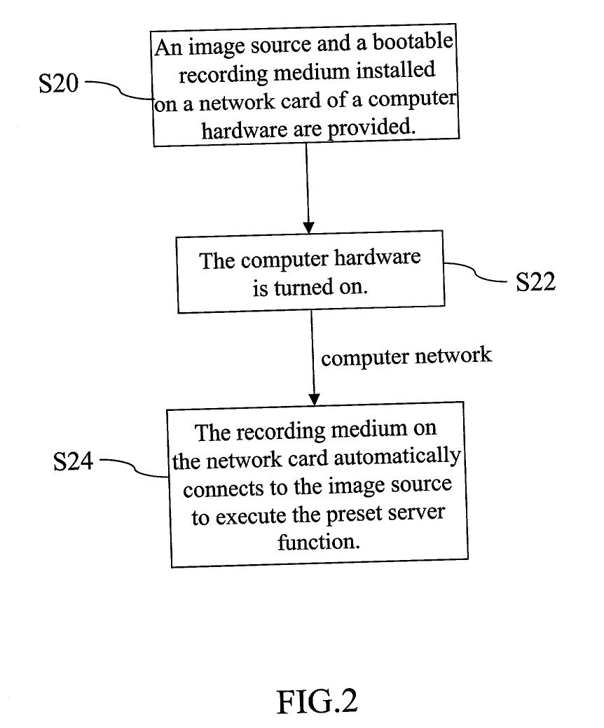

In addition to the above embodiment, the present invention can also generate server functions through direct installation via computer network. As shown in FIG. 2, a method of using recording medium to quickly generate server function comprises the following steps:

First, as Step S20 shows, an image source and a bootable recording medium are provided. These two perform transmission of information via computer network. A read-only image file, which is formed of the OS kernel and various kinds of server functions, is stored in the image source. Each kind of server function has a corresponding parameter setting. The bootable recording medium has a turning-on mechanism, simple communications function, parameter settings, and embedded optimized server functions therein. The bootable recording medium is directly installed on a network card of a computer hardware.

Next, as Step S22 shows, after the computer hardware is turned on, it will utilize the recording medium on the network card to automatically connect to the image source via computer network. As Step S24 shows, different parameter settings are matched to find out corresponding read-only image files of server functions so as to automatically perform the required server function.

The present invention utilizes the recording medium to let the installation and use of server be very simple, fast, and convenient. Therefore, a common user can perform and use these special server functions themselves without depending on other professionals. Additionally, the present invention can let computers to be eliminated through competition exploit their value again, provide network services immune to threat of virus, and can popularize computer network services.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A recording medium capable of quickly generating server functions and used in computer network to generate various kinds of server functions, said recording medium comprising a blank recording medium, said blank recording medium having a read-only image file of an OS having server functions and a boot mechanism therein.

2. The recording medium capable of quickly generating server functions as claimed in claim 1, wherein said server is selected among the group composed of MAIL server, network address translation server (NAT), domain name server (DNS), PROXY server, network attached storage (NAS) server, and dynamic host configuration protocol (DHCP) server.

3. The recording medium capable of quickly generating server functions as claimed in claim 1, wherein said recording medium is a CD disk or a device supporting boot function.

4. The recording medium capable of quickly generating server functions as claimed in claim 1, wherein said recording medium is placed in a reader of a computer hardware, and said computer hardware generates the required server function by using said recording medium after being turned on.

5. A manufacturing method of a recording medium capable of quickly generating server functions, comprising the steps of:
(a) providing an OS kernel for driving a computer hardware;
(b) adding server functions and a boot mechanism in said OS kernel to assembly an OS; and
(c) writing said OS into a recording medium to produce a recording medium source disk.

6. The manufacturing method of a recording medium capable of quickly generating server functions as claimed in claim 5, wherein said Step (b) further comprises a step of removing all software elements not pertinent to preset server functions.

7. The manufacturing method of a recording medium capable of quickly generating server functions as claimed in claim 5, wherein said Step (b) further comprises a step of embedding in the required optimization of said server functions.

8. The manufacturing method of a recording medium capable of quickly generating server functions as claimed in claim 5, wherein a step (d1) of replicating said recording medium source disk in large quantity by using the printing technique to manufacture final recording media is further included after said Step (c).

9. The manufacturing method of a recording medium capable of quickly generating server functions as claimed in claim 5, wherein a step (d2) of regenerating said recording medium source disk to manufacture final recording media applicable to different environments by using the rewritable function of recording medium is further included after said Step (c).

10. The manufacturing method of a recording medium capable of quickly generating server functions as claimed in claim 8 or 9, wherein said final recording medium is placed in a target machine so that preset server functions can be automatically generated after said target machine is turned on.

11. The manufacturing method of a recording medium capable of quickly generating server functions as claimed in claim 5, wherein said server is selected among the group composed of MAIL server, network address translation server (NAT), domain name server (DNS), PROXY server, network attached storage (NAS) server, and dynamic host configuration protocol (DHCP) server.

12. The manufacturing method of a recording medium capable of quickly generating server functions as claimed in claim 5, wherein said recording medium is a CD disk or a device supporting boot function.

13. A method making use of a recording medium to quickly generate server functions, comprising the steps of:
providing a bootable recording medium having a boot mechanism, simple communications functions, and parameter settings therein, installing said bootable recording medium on a network card of a computer hardware;
storing a read-only image file of an OS formed of an OS kernel and various kinds of server functions into an image source, each said server function having a corresponding parameter setting; and
connecting said computer hardware to said image source by using said recording medium on said network card via computer network after said computer hardware is turned on, different parameter settings being matched to automatically execute different server functions.

14. The method making use of a recording medium to quickly generate server functions as claimed in claim 13, wherein said server is selected among the group composed of MAIL server, network address translation (NAT) server, domain name server (DNS), PROXY server, network attached storage (NAS) server, and dynamic host configuration protocol (DHCP) server.

15. The method making use of a recording medium to quickly generate server functions as claimed in claim 13, wherein optimized server functions are embedded in said bootable recording medium.
